(19) United States
(12) Patent Application Publication
(10) Pub. No.: US 2010/0094804 A1
(43) Pub. Date: Apr. 15, 2010

(54) Method and Device for Updating a Database, and Computer Program Product

(75) Inventors: Martin Pfeifle, Seewald (DE); Volker Sasse, Lappersdorf (DE); Jong-Hyun Suh, Seoul (KR); Uwe Tantz, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/518,257

(22) PCT Filed: Dec. 4, 2007
(86) PCT No.: PCT/EP07/63262

§ 371 Date: Dec. 8, 2009

(30) Foreign Application Priority Data
Dec. 8, 2006 (DE) 10 2006 057 977.1

(51) Int. Cl. G06F 17/30

(52) U.S. Cl. 707/609; 707/E17.005

(57) ABSTRACT

A database system includes a database management system and a database. The database comprises at least one file to be updated (OLD_FILE) which is stored on a storage device. To update the database, the file to be updated (OLD_FILE) is deleted. A new file (NEW_FILE) from the database with current data is transferred to the storage device using a transfer command (SQL_COPY) which is authored in a database language of the database system.

### PRIORITY CLAIM

This is a U.S. national stage of application No. PCT/EP2007/063262, filed on Dec. 4, 2007, which claims Priority to the German, Application No.: 10 2006 057 977.1, filed: Dec. 8, 2006, the contents of both being incorporated herein by reference.

### BACKGROUND OF THE INVENTION

1. Field of the Invention

The invention relates to a method and to a device for updating a database. A database system comprises a database management system and the database. The database comprises at least one file to be updated which is stored in a storage device. Furthermore, the invention relates to a computer program product which comprises a computer-readable storage medium with program instructions which are arranged for carrying out the method for updating the database.

2. Prior Art

A modern database system typically comprises a database and a database management system. The database comprises one or more files stored in one or more storage devices. The files contain the database data. The database management system is provided for managing the data of the database. Managing the database can comprise, for example, searching, reading, and/or writing data into the corresponding database files. In particular, a file which is no longer current can be updated by an updating command which comprises a combination of search, read, and/or write commands.

In WO 2005/008407 A2, a joint file updating system is disclosed. If a receiver already has an immediately preceding version of a current file, he is only sent a difference file for updating the file. If not, the receiver is sent the complete current file.

In U.S. Pat. No. 5,953,725 A, a network-based multimedia information system is disclosed. Database operations are recorded in a version packet. These can be processed step by step in order to update a database content. The database can be exchanged by an external management of a database arrangement and the system can be completely redesigned by this means.

In U.S. Pat. No. 5,893,119 A, a method for fusing system differences is disclosed. In a first method, system files are initially copied into a backup memory and changed files are copied as incremental backup copies into the backup memory. Each changed file is copied completely. In a second method, changes in files are stored as difference files.

In WO 98/54662 A1, a method, a computer program product and a system for distributing changes which have been carried out in a data memory to remote users which have copies of the data memory are disclosed. In this arrangement, sequential version numbers are used for distinguishing between different versions of the data memory.

### SUMMARY OF THE INVENTION

An object of the present invention is to create a method and a device for updating a database which provides a simple, fast and resource-saving manner for updating the database, particularly files to be updated in the database.

According to one embodiment of the invention, the invention is characterized by a method and a device for updating a database of a database system. The database system comprises a database management system and the database. The database comprises at least one file to be updated. The file to be updated is stored in a storage device. To update the database, the file to be updated is overwritten with a new file of the database comprising current data by means of a transfer command. The transfer command is written in a database language of the database system.

This provides for updating the database in a particularly simple manner. Furthermore, the database is updated rapidly and/or in a resource-saving manner, particularly if the new file differs greatly from the old file. In this context, greatly means that the file differs from the file to be updated by at least a predetermined measure. The database language is preferably SQL, but can also be an alternative database language. The transfer command is preferably a copy command in which the source file is not necessarily retained. The transfer command preferably represents a transaction with several substeps. For example, the file to be updated can be overwritten step-by-step with the new file.

In one embodiment of the invention, it is checked how much the new file differs from the file to be updated. The file to be updated is overwritten with the new file only if the new file differs from the file to be updated at least by a predetermined measure. The file to be updated is left in the storage device and updated based on the new file, if the new file and the file to be updated differ at the most or precisely by the predetermined measure. This can contribute to the file to be updated being replaced entirely by the new file only if this is more rapid and/or more resource-saving than updating the file to be updated in based on the new file. The predetermined measure can be determined, for example, based on the hardware available.

In one embodiment of the invention, the file to be updated is overwritten with the new file if 20% or more of the new file differs from the file to be updated. This contributes to entirely replacing the file to be updated with a new only if it is more rapid and/or more resource-saving than updating the file to be updated.

In one embodiment of the invention, the database comprises at least one first and one second file to be updated. It is checked how much the first or the second file to be updated, respectively, differs from a first or second new file, respectively. Based on this check, at least one of the two files to be updated is overwritten with the corresponding new file. The other one of the two files to be updated is only updated in the storage device. This provides for the simple, rapid and/or resource-saving updating of the database if several files are updated in one operating cycle and if the new files differ from the corresponding files to be updated to a differently great extent.

In one embodiment of the invention, the file to be updated is saved and/or deleted before the overwriting.

The embodiments of the method can be easily transferred to advantageous embodiments of the device.

According to one embodiment of the invention, the invention is characterized by a computer program product which comprises a computer-readable storage medium with program instructions. The program instructions are arranged for carrying out the method explained in the preceding text.

### BRIEF DESCRIPTION OF THE DRAWINGS

In the text which follows, the invention will be explained in greater detail with reference to diagrammatic drawings, in which:

FIG. 1 is a database system;

FIG. 2 is a database to be updated and a new database; and

FIG. 3 is a flow chart of a program for updating the database.

Elements of the same design or function are identified by the same reference symbols in all figures.

### DETAILED DESCRIPTION OF THE DRAWINGS

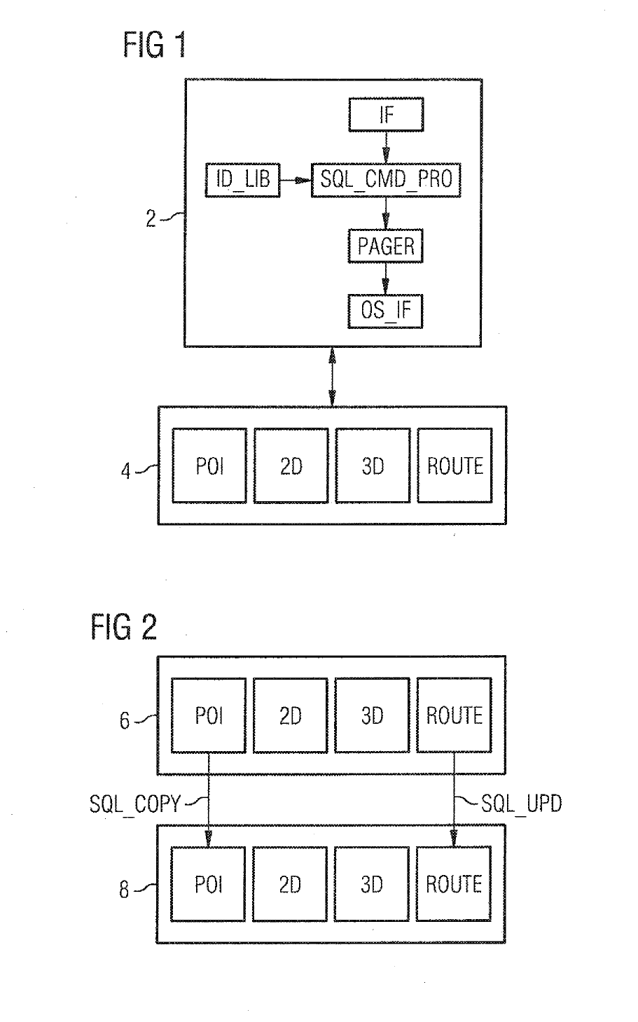

A database system (FIG. 1) comprises a database management system 2 and a database 4. The database 4 comprises at least one file. The file is stored in a storage device of a computer. The database 4 preferably comprises several files which are stored in the storage device or several further storage devices. Each file preferably comprises at least one block which preferably comprises 1024 bytes. The storage device is preferably a hard-disk storage unit. As an alternative or additionally, the storage device comprises a mobile data medium. The database system and/or the database 4 comprises a relational database system or a relational database 4, respectively, and/or a proprietary database system or a proprietary database 4, respectively.

The database management system 2 is arranged for managing data stored in the database 4, particularly in the storage device. The database management system 2 comprises a user interface IF, an SQL command processor SQL_CMD_PRO, a pager PAGER, a directory ID_LIB of index structures and an operating system interface OS_IF. The database management system 2 communicates with the database 4. As an alternative to the SQL command processor SQL_CMD_PRO, an alternative program module can be used. For example, the alternative program module can be selected based on the programming language used. Furthermore, if the database system comprises a proprietary database system or a proprietary database 4, respectively, a proprietary program module is provided as an alternative to the SQL command processor SQL_CMD_PRO.

The user interface IF preferably comprises input and output units by means of which command lines are input into the database management system 2. The command lines are preferably written in a database language, preferably in SQL. The user interface IF forwards the written command lines to the SQL command processor SQL_CMD_PRO.

The SQL command processor SQL_CMD_PRO determines a software execution plan based on the command lines and preferably based on at least one available index structure which is stored in the directory ID_LIB of the index structures. The software execution plan is a program section which is used for making the access to the data as efficient as possible.

The software execution plan is transferred to the pager PAGER by the SQL command processor SQL_CMD_PRO. The pager PAGER is used for determining a hardware execution plan based on the software execution plan. The hardware execution plan is representative of how hardware, for example the hard disk storage unit and/or the mobile data medium which can comprise the database 4, must be driven for processing the software execution plan.

The hardware execution plan is transferred to the operating system interface OS_IF which converts the hardware execution plan into corresponding actuating signals for the storage device in which the data are stored.

The database management system 2 is preferably stored in a storage device of a navigation system. As an alternative, the database management system 2 can also be used independent of the navigation system. For example, the database management system 2 can be stored in a computer and used, for example, for managing music data. Furthermore, the database 4, particularly a file of the database 4, is preferably stored in a storage device of the navigation system. In this context, the database 4 preferably comprises a file POI of interesting locations, a file 2D for two-dimensional map data, a data 3D for three-dimensional map data and/or a route file ROUTE for data for finding routes.

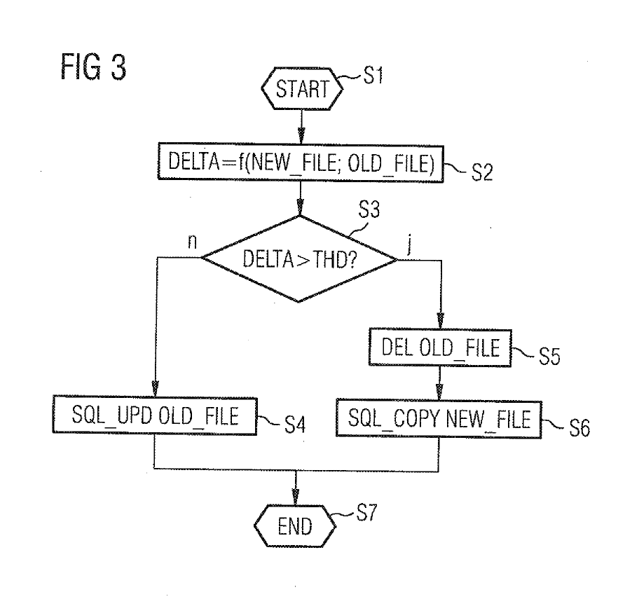

The interesting locations, the map data and/or the route data can change over the course of time. It is therefore regularly necessary to update outdated files. To update a file OLD_FILE to be updated, the database management system basically has two different options (FIG. 3).

A first option is to search the elements to be updated in the file to be updated OLD_FILE by means of an update command SQL_UPD (FIG. 2) which is written in the database language, and replace these by current elements of a current file NEW_FILE. This is advantageous especially if the new file NEW_FILE differs only slightly from the file to be updated OLD_FILE. In this context, slightly preferably means that the file to be updated OLD_FILE differs from the new file NEW_FILE by a predetermined measure at the most.

A second possibility consists in that the file to be updated OLD_FILE is overwritten with the new file NEW_FILE comprising the current data based on a transfer command SQL_COPY written in the database language. The transfer command SQL_COPY is preferably a copy command. However, it is not necessary in this context that the source file is still present in a corresponding source storage device after the copying process. The file to be updated OLD_FILE is preferably saved before the overwriting. After the file to be updated OLD_FILE has been saved, the file to be updated OLD_FILE can be deleted from the storage device or overwritten directly.

The updating command SQL_UPD and the transfer command SQL_COPY are preferably each representative of one transaction. The transactions preferably comprise substeps. For example, the file to be updated OLD_FILE can be updated or overwritten, respectively, always one block of the file to be updated OLD_FILE, comprising 1024 bytes, at a time. Furthermore, the file to be updated OLD_FILE can be saved before the overwriting, in particular, the file to be updated OLD_FILE can be saved and/or deleted block by block.

The predetermined measure is preferably determined empirically. For this purpose, the file to be updated OLD_FILE can be updated, for example on the navigation device, in dependence on files changed by a different extent and first time intervals can be determined which are needed for this updating. In addition to the first time intervals, second time intervals are preferably determined which are needed for overwriting the file to be updated OLD_FILE with the files changed by a different extent. The greater the differences between the file to be updated OLD_FILE and the files changed by a different extent, the more it pays, as a rule, to overwrite the file to be updated OLD_FILE with the corresponding file changed by a different extent, particularly the new file NEW_FILE. The first and the second time interval can then be used for finding the suitable predetermined measure.

The predetermined measure can be, for example, between ten and thirty percent. In this context, the file to be updated OLD_FILE is deleted and replaced by the new file NEW_FILE only if the new file NEW_FILE differs from the file to be updated OLD_FILE by ten to thirty percent.

If, for example, the database 4 comprises a database 6 to be updated and the database 6 to be updated comprises a file POI of interesting locations which differs from a new file POI of interesting locations beyond the predetermined measure, it is preferably replaced by the new file POI of interesting locations by means of the transfer command SQL_COPY. If during the same updating, the route file ROUTE to be updated of the database 6 to be updated differs by less than the predetermined measure from the new route file ROUTE, the route file ROUTE to be updated is updated by means of the updating command SQL_UPD.

In the storage device of the navigation system, a program for updating the database 4 is preferably stored. A computer, particularly the navigation system in which the database management system is stored can also be called a device for updating the database. The program for updating the database is preferably started in a step S1 in which variables are initialized, if necessary.

In a step S2, a difference value DELTA which is representative of how greatly the file to be updated OLD_FILE differs from the new file NEW_FILE is determined based on the file to be updated OLD_FILE and the new file NEW_FILE.

In a step S3, it is checked whether the difference value DELTA is greater than a predetermined threshold value THD. The predetermined threshold value THD preferably represents the predetermined measure. If the condition of step S3 is met (Y), the processing is continued in a step S5. If the condition of step S3 is not met (n), the processing is continued in a step S4.

In step S4, the file to be updated OLD_FILE is updated by means of the updating command SQL_UPD and left in the storage device.

In step S5, the file to be updated OLD_FILE is stored by means of a store command SAVE and thus saved and/or deleted by means of a delete command DEL. In particular, a block of the file to be updated OLD_FILE can be stored, saved, or deleted, respectively, in step S5.

In a step S6, the new file NEW_FILE is transferred to the storage device by means of the transfer command SQL_COPY and the file to be updated OLD_FILE is overwritten if it has not yet been deleted in step S6. As an alternative, the delete command DEL can be comprised by the transfer command SQL_COPY. The transfer command SQL_COPY is preferably a copy command which automatically stores the new file NEW_FILE instead of the file to be updated OLD_FILE. In particular, a block of the file to be updated OLD_FILE can be overwritten with a block of the new file NEW_FILE in step S6.

In a step S7, the program can be terminated. The program is preferably processed again starting with step S1 for all files to be updated, OLD_FILE, of the database 6 to be updated. In particular, the program can be processed individually for all blocks of the file OLD_FILE to be updated.

In addition to the storage device, the program for updating the database and/or the database management system can be stored in a mobile storage unit. The mobile storage unit comprises program instructions which are arranged for updating the database 6 to be updated. The mobile storage unit is, for example, a CD, DVD, a memory stick, and/or flash memory.

An advantage of updating the database 4 by means of the updating command SQL_UPD is that only the data actually updated is updated. After the updating, however, logically associated data, particularly old and updated data which are logically associated, can no longer be spatially associated in the storage device. In contrast, updating by the transfer command SQL_COPY offers the advantage that data which is logically associated can be stored in a spatially and/or physically coherent manner in the storage device. For example, map sections, particularly the graphical data for representing the map sections are preferably stored spatially and/or physically coherently in the storage device so that the corresponding map section can be rapidly read in. This is preferably also taken into consideration when generating the new file NEW_FILE. In contrast, parts of the map sections can be stored at different locations in the storage device by means of the updating command SQL_UPD when updating the corresponding map section, particularly if only a part of the corresponding map section is updated. To represent the map section, the read head of the storage device must then be brought to locations of the storage medium of the storage device which are spaced apart by different amounts, which additionally requires time.

The invention is not restricted to the exemplary embodiments specified. For example, the database system can be used independently of the navigation system. Furthermore, the database can comprise fewer or more files.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for updating at least one file of a database of a database system which comprises a database management system and the database, the at least one file being stored in a storage device, the method comprising:
overwriting the at least one file with a new file using a transfer command, the new file comprising current data,
wherein the transfer command is written in a database language of the database system.

9. The method for updating at least one file of a database according to claim 8, further comprising:
determining a difference between the new file and the at least one file to be updated;
performing the steps of overwriting the at least one file to be updated with the new file only if the difference between the new file and the at least one file to be updated is at least a predetermined amount; and
updating the at least one file to be updated based on the new file if the difference between the new file and the at least one file to be updated is at most the predetermined measure wherein the at least one file to be updated is left in the storage device.

10. The method for updating at least one file of a database according to claim 8, further comprising:
deleting the at least one file updated; and
transferring the new file to the storage device if the new file differs from the at least one file to be updated by ten to thirty percent.

11. The method for updating at least one file of a database according to claim 10, wherein the database comprises at least one first and one second file to be updated, the method further comprising:
determining how much the first or the second file to be updated respectively, differs from a first or second new file, respectively; and
based at least in part on the determination:
updating at least one of the first and the second file by overwriting the at least one of the first and the second file with respective first and second new file; and
updating the other of the first and the second file in the storage device.

12. The method for updating at least one file of a database according to claim 10, wherein the at least one file to be updated is at least one of saved and deleted before the overwriting.

13. A device for updating a database file in a database system, the database system that comprises:
a database management system; and
a database, the database comprises at least one file to be updated which is stored in a storage device,
the device configured to overwrite the least one file to be updated with a new file using of a transfer command written in a database language of the database system.

14. A computer program product comprising a computer-readable storage medium with program instructions which are arranged for carrying out the method as claimed in claims 8.

15. The method for updating at least one file of a database according to claim 9, wherein the at least one file to be updated is updated one block at a time.

16. The method for updating at least one file of a database according to claim 9, wherein the predetermined amount is 10 to 30 percent.

17. The method for updating at least one file of a database according to claim 9, wherein the predetermined amount is 20 percent.

18. The method for updating at least one file of a database according to claim 9, wherein at least one file is configured to provide data to a navigation device.

19. The device, for updating data box file, according to claim 13, wherein the database management system is so stored in a memory of a navigation system.
